(19) United States
(12) Patent Application Publication
(10) Pub. No.: US 2008/0092189 A1
(43) Pub. Date: Apr. 17, 2008

(54) Web video distribution system for e-commerce, information-based or services websites

(75) Inventors: Gary Baker, Agoura Hills, CA (US); Patrik Braun, Los Angeles, CA (US)

Correspondence Address: LUMEN PATENT FIRM, INC., 2345 YALE STREET, SECOND FLOOR, PALO ALTO, CA, 94306, US

(73) Assignee: ClipBlast, Inc.

(21) Appl. No.: 11/644,735

(22) Filed: Dec. 22, 2006

Related U.S. Application Data
(60) Provisional application No. 60/846,583, filed on Sep. 21, 2006.

(51) Int. Cl. H04N 7/173

(52) U.S. Cl. 725/112; 725/113; 725/110

(57) ABSTRACT

A method of presenting video content to clients of an e-commerce, information-based or services website is provided enabling their website designers or providers to benefit from the vastly growing amount of video content on the Internet and automate the integration of already generated video content into their web services pages, products and services.

### CROSS-REFERENCE TO RELATED APPLICATIONS

This application is cross-referenced to and claims priority from U.S. Provisional Application 60/846,583 filed Sep. 21, 2006, which is hereby incorporated by reference.

### FIELD OF THE INVENTION

The invention relates to video distribution methods and systems for subscribing to video links or clips and presenting video content related to the subscribed links or clips to clients of e-commerce, information-based or services websites, whereby the subscribed video content is matched to client's queries or data request and played-back in the respective webpage or web widget as a result of the search query or data request.

### BACKGROUND OF THE INVENTION

The amount of video content available over the Internet has been vastly expanding over the last few years. At the same time, the use and demand for video content across the Internet has significantly increased. Some of the key enablers for these changes have been the increase in bandwidth, computer processor speed and digital video technology, which have significantly decreased the download time for video content onto a computer. Progress has also been made with video search engines allowing people to search for video content online (see e.g. Google Video, and U.S. Pat. Nos. 6,859,799 and 6,925,474). Furthermore, websites are more and more integrating video content to enhance their web pages or disseminate information.

One downside to adding video content on websites is that it could be extremely time consuming and a significant expense to the website provider when the videos have to be generated from scratch; i.e. from idea to the actual video production and integration on the web page. As the present invention addresses, it would be much more efficient and effective if website designers or providers could benefit from the vastly growing amount of video content on the Internet and automate the integration of already generated video content into their web services pages, products and services. For example, if you are an online travel agency and would like to support each vacation web page or trip search with video content you have the option of creating videos for each and every vacation spot or you could utilize videos available on the Internet. The present invention addresses this problem and proposes a solution that would allow for Internet available video content to be an integral part of websites, web pages, blogs and web widgets, without the need for the website provider to create the videos.

### SUMMARY OF THE INVENTION

The present invention is a method of presenting video content to clients of an e-commerce, information-based or services website. A categorized and indexed database is developed or made available. Video content that is unorganized and widely distributed on the world-wide-web is identified through web-crawling or RSS-feeds. The identified links of the video content is then stored on a centralized server, after which several processes (e.g. parsing, categorizing and indexing) take place to make the video content available as a part of the database. The database is then made accessible to the providers of the e-commerce, information-based or services websites. They can then identify and request one or more of video links or video clips from the video-link database/website. This request can then be formalized as a subscription which could include obtaining authorization or a license from the video-link database/website to link the requested video information to their website page(s). The e-commerce, information-based or services provider then creates one or more relationships on their respective e-commerce, information-based or services website or website pages. These relationships are established between the subscribed video links and parts of their e-commerce, information-based or services website. A client using their own web-browser interacts with the e-commerce, information-based or services website. The client enters a query or request on the respective e-commerce, information-based or services website via his/her web-browser. In response to the client's query, request or click-event, a matching process is initiated at the e-commerce, information-based or services website. The objective of the matching step is to match the information entered or requested by the client in the respective e-commerce, information-based or services website to the one or more of the created (subscribed) relationships. Once a match is identified, the matched web-page(s) together with the matched (subscribed) video content(s) is presented in a webpage in the client's web-browser. The matched and related video content is then automatically played-back to the client in the respective webpage, a separate webpage or a separate video player in the client's web-browser. When playing back the video, the actual video content or clip could either be downloaded from the original site where it was identified in step (a) or from the video-clip-website.

The invention provides a much more efficient and effective way for website designers or providers by benefiting from the vastly growing amount of video content on the Internet and automate the integration of already generated video content into their web services pages, products and services.

### BRIEF DESCRIPTION OF THE FIGURES

The present invention together with its objectives and advantages will be understood by reading the following description in conjunction with the drawings, in which:

FIG. 1 shows a flow diagram according to the present invention

FIG. 2 shows an example of implementation according to the present invention.

### DETAILED DESCRIPTION OF THE INVENTION

The present invention turns the Internet into a video distribution platform. The ultimate goal is to present video content, that has already been generated by others and is available on the Internet, though unorganized and distributed, to a client of an e-commerce website, an information-based website or a services website. In an alternate embodiment the presented video content in this invention is all available video excluding advertising videos produced by an advertiser.

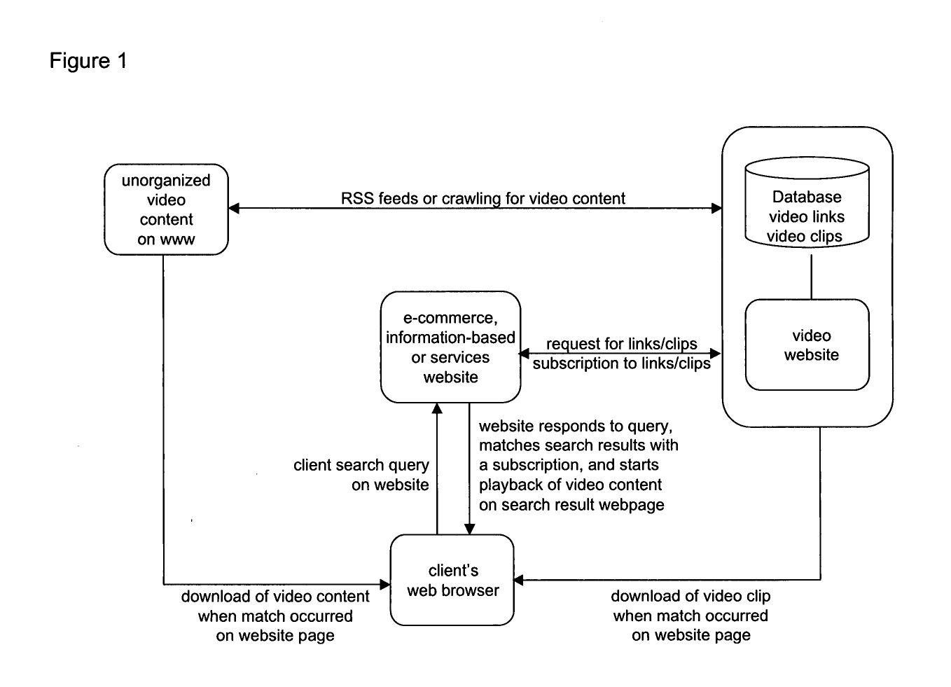

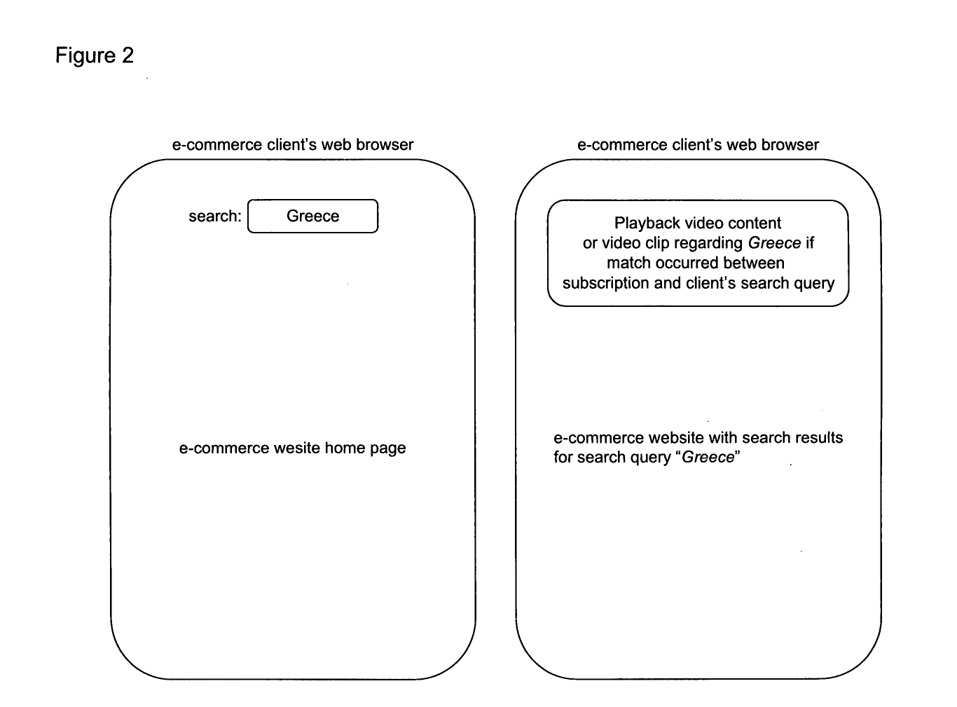

The presented video matches the content requested through a query or keywords or tags from a website or web widget of a webpage either for illustration purposes or to enhance the webpage desired message being provided by the e-commerce, information-based or services websites. The videos are instantly served to an e-commerce website, an information-based website or a services website and are based on their client's search queries, client's keywords, client's tags, client's product selection and other means of clients' and/or marketing-defined requirements. The invention includes several components that are integrated as a video distribution system and method, which are now discussed (see also FIGS. 1 and 2).

### Sources

The first step in the process is identifying sources of video clips and/or video files that are unorganized, distributed and available on the Internet. This could be a web site with links to video on each page, or an RSS feed that has been identified as containing video clips, or based on crawling the web and identifying video. In an alternate embodiment, it could also be a file-based representation of a company's database of video assets.

The most important aspect of the sources is that they contain one or more Internet URL links that correspond to a video media file, or a page with a video media file on it. The identification or search process could also match a set of criteria for determining the contents of this URL containing media assets. For instance, site A serves each video file in a Macromedia Flash player. Each page on site A contains a separate video file. The identification for this source would include checking the pages of this site for an appropriate Flash player tag. Site B serves its video as MPEG4 files for downloading to a portable device. Identifying Site B as a video site involves checking for at least one active link where the extension of the file is .mp4 or where the mime-type of the downloaded content is announced as video/mp4.

Once a source is identified as having video files, each video file will be obtained and meta-data about the video data will be parsed. As mentioned in the examples about finding sources of video, the method of parsing each site's video pages must recognize the differences. For each site that the crawling algorithm will visit, a new parser is added and that parser is specifically configured to process the meta-data for that video clip. This process involves determining which data on a video page defines the video clip's title, media file, published date, and other relevant meta-data. Once all the data on a page is parsed, the video clip is stored in a waiting area for approval to be stored. If all the meta-data that is desired or required is present the video clip will be stored directly into the database.

A clip is stored in our waiting area if a category could not be determined or other critical meta-data is missing. It will wait there until one of our editors looks at it to fill in the missing data from the site the video originally came from. Once the video content has been approved the video clip or file is indexed and categorized and stored in a database in such a form so that the video data becomes searchable. It can for example be categorized by source, content, category or abstract category. In one embodiment, a web accessible framework is provided to allow third parties or people to search and generate views of the video media list based on criteria they select that match one or more of the categorization criteria

### Ingest

Periodically each of its video sources is checked (RSS feeds, crawling the Web or manually) for new content. For sources that provide an RSS feed this step includes downloading a copy of the feed document, parsing the format, and checking each clip video URL for uniqueness. If all three of those steps succeed, the clip video and its meta-data are stored for processing later in the Clip Pipeline (see below). For sources that require web crawling, a copy of each page is periodically downloaded of each accessible URL on their site. That URL gets checked for indications that it's a video media asset, or has a video media asset included in its markup. If one of those conditions is true, the page is parsed (as described above) and sent to the database for further processing to identify the meta-data that is going to be used for indexing and searching. Again, to become searchable the meta-data for a video is stored in a searchable index. In one embodiment, for speed of searching all the relevant text is made lowercase, has common English words that will not aid in searching removed, and is reduced to a stemmed form. The last process allows the search phrase “lazy” to match any document containing any of the following “lazy, laziness, laziest”. Certain elements of the meta-data are stored in separate fields and given a boosting score, such that if a person's query matches that field, the document will appear closer to the beginning of the results.

### Clip Pipeline

The video data is further prepared for human consumption or use through the Video Search Website. This process forces each incoming video clip to go through several sub-processes to verify and possibly add meta-data. In one embodiment, the list of sub-processes follows the following logic:
1. download the actual media asset
2. extract any English subtitles
3. extract any closed captioning
4. check for explicit content
5. categorize the clip (as described above)
6. identify any related thumbnail images
7. identify a possible flash-based embeddable asset
8. add document boosting for sources that provide the most clips
9. subtract document boosting for various business reasons

For some clips it's possible to add meta-data that wasn't originally available from the data source. For example, converting the audio track into a searchable text transcript or identifying character names from a TV show by matching an actor or actress's name. In general, adding keywords that a user might enter to identify a video, or that would allow us to identify video that are related to other video in non-obvious ways.

### Approval Process

Once a video clip has made it through the Clip Pipeline and before it is sent into the publicly Searchable Video Website, a final check of the content is performed. This final check is performed by an editor (a person or (semi)-automatically). In one embodiment, one could automate the process and all video over two days old could be given a category automatically and swept into the index without editorial intervention.

### Video Search Website and Subscription

External sites, preferably e-commerce websites, information-based or services websites, could interface with the web-accessible Video Distribution Engine by sending a set of parameters that describe the kind of results they need. The objective here is for those sites to request specific video or content that they can link to their sites, and once identified subscribe to those links as shown in FIG. 1.

In one example, where a travel web site is seeking video to enhance the user's experience while booking a flight, a main phrase is required from the external site that is normalized to represent a natural language phrase. For example, the travel website should convert each airport code into the city name before passing the request for video. Other parameters an external website could specify include categories, and sources, to further filter the results. Furthermore, for external websites that would like to list multiple pages of video links, they can send a page and offset number so that they can paginate and give their users a rich user-experience. This request for video could happen through either a traditional HTTP GET or POST. Or over through a Web Services interface layer such as SOAP.

An external website user can also enter a search query and save it in the Video Search Website's database. Each time they come back to that site and enter their username and password, they could see the latest video content for the query they have saved. The user could also instruct the Video Search Website to email new results to them periodically.

Once the external website identified video clips, it can then request a subscription to those video clips to be used and information about the video clip is linked to their website (see FIG. 1). This subscription can also be in the form of license or an authorization from the video website as long as there is an established relationship between the two entities, i.e. video website and external website.

### Perceived Relevancy

Search queries by users on the Video Web Database are usually fairly short and often inadequately describe their actual intention. A user might want to watch the trailer of a recent movie and enters the search phrase “A Scanner Darkly” without the word trailer in it. At this point the search algorithm has to make some guesses as to what the user really intended with that phrase. One approach is to structure the content in the index in tiers from “most likely” to “least likely”. The tiers for entertainment type content are The Movie/Show Itself, Trailers, Interviews, Cast member videos, User video about the movie/show.

### Video Matching

Once the external website has established the video content/clip/link subscription with the Video Website, a client of that external website can now benefit from that subscription. Clients perform search queries, enter keywords, have certain tags, make a product selection or any other means of clients' request on the e-commerce website, an information-based website or a services website (i.e. external websites). The subscription matches one or more of these client interactions which automatically follows with a web response to the client from the external site's website whereby the videos are instantly served and automatically played-back to the client in their respective web-browser.

In the matching process, the client's interaction, e.g. query term, along with any filtering instructions is checked against the index associated with the subscribed video clip (that is the index present in the Video Database). The match can be fine tuned by e.g. limiting the number of results as specified by the client. Another match fine tuning parameter is specifying a starting number and then returning the matched results according to that number and counting from there till the end of the list. In cases where filtering criteria (e.g. category or source) are provided, any result returned must match or not match depending on how the criteria are specified. For instance [phrase=San Francisco, source=20, sourceNot=50, limit=10] will return the top 10 results with the phrase San Francisco where the source has an id in our system of 20 and where the source is not id 50.

### EXAMPLE

In the following example video clips/files are served by the video website to online retailers to support and enhance the shopping experience. In the particular example, video files are served to an online travel sites in support of booking travel (FIG. 2). When searching e.g. Expedia for Flights to Greece, the system passes video links to the client who can watch one or more videos about Greece in support of their buying decision. It is noted that the video is supplied to the client no via the online travel site, but either directly from the original video site or from the video website database as is shown in FIG. 1.

In this example, a web content provider like Expedia, recognizes that a user is in the process of selecting a trip by the pages they are downloading. The Expedia application delivering their regular web pages will now add a piece of code to the HTML markup that when run accesses the servers where the video clips are stored (see FIG. 1). These servers then return the appropriate data in e.g. XML format that the page transforms into the appropriate format with an XSLT stylesheet. Depending on how the Expedia application would like to display the data a different transfer format like DHTML could be chosen. DHTML would be able to render a popup layer with a few short movies and some descriptive text, without the Expedia service having to alter their pages significantly.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. For example, one could convert all video media files into a single format. In another variation one could convert a video file into another file that is up to the first 10 seconds long (i.e. a portion of the video content). That file could then be converted into a flash application and stored in a web accessible directory. The filename could then also be added to the meta-data for the video clip. One could also store preferences for the external website provider regarding their search and subscription history and store that information in the database. Similarly, one could obtain and store preferences for the client of those external website regarding their query history. This could be stored in relation to the external website or linked to the video website database where the subscription is stored. All such variations are considered to be within the scope and spirit of the present invention as defined by the following claims and their legal equivalents.

What is claimed is:

1. A method of presenting video content to clients of an e-commerce, information-based or services website, comprising:
(a) identifying video content which is unorganized and distributed on the world-wide-web through web-crawling or identifying RSS-feeds;
(b) storing the links of each of said identified video content in a database on a centralized server;
(c) categorizing and indexing each of said identified video links based on information about its associated video content;
(d) making available on said world-wide-web said categorized and indexed database as a video-link-website;
(e) an e-commerce, information-based or services provider having respectively an e-commerce, information-based or services website identifying and requesting one or more of said video links from said video-link-website;
(f) said e-commerce, information-based or services provider subscribing to one or more of said video links wherein said subscription is obtained from said video-link-website;
(g) said e-commerce, information-based or services provider creating one or more relationships on said respective e-commerce, information-based or services website between said one or more subscribed video links and one or more parts of their e-commerce, information-based or services website pages;
(h) a client of said e-commerce, information-based or services website using said respective e-commerce, information-based or services website through a client's web-browser, and said client entering a query on said respective e-commerce, information-based or services website via said client's web-browser;
(i) matching at the e-commerce, information-based or services website said query information entered by said client in said respective e-commerce, information-based or services website to said one or more of said created relationships;
(j) presenting in one webpage in said client's web-browser the webpage each of the matched and related web page and subscribed video contents; and
(k) automatically playing back to said client and in said webpage in said client's web-browser the matched and related video content whereby for said playback the video content is downloaded from the original site where it was identified in step (a).

2. The method as set forth in claim 1, further comprising storing a portion of said video content in said centralized database as a video clip.

3. The method as set forth in claim 1, wherein said categorizing and indexing further comprises routinely updating said categorization and indexing based on relevance parameters regarding said identified video content.

4. The method as set forth in claim 1, further comprising storing preferences for said e-commerce provider regarding said provider's search and subscription history on said categorized database.

5. The method as set forth in claim 1, further comprising storing preferences for said client regarding said client's query history on said e-commerce, information-based or services website.

6. The method as set forth in claim 1, further comprising presenting or distributing said database to individuals, marketers, webmasters or bloggers.

7. A method of presenting video content to clients of an e-commerce, information-based or services website, comprising:
(a) identifying video content which is unorganized and distributed on the world-wide-web through web-crawling or identifying RSS-feeds;
(b) creating video clips of the identified content, wherein said video clip is a portion of said video clip;
(c) storing the video clips of each of said identified video content in a database on a centralized server;
(d) categorizing and indexing each of said identified video clips based on information about its associated video content;
(e) making available on said world-wide-web said categorized and indexed database as a video-clip-website;
(f) an e-commerce, information-based or services provider having respectively an e-commerce, information-based or services website identifying and requesting one or more of said video clips from said video-clip-website;
(g) said e-commerce, information-based or services provider subscribing to one or more of said video clips wherein said subscription is obtained from said video-clip-website;
(h) said e-commerce, information-based or services provider creating one or more relationships on said respective e-commerce, information-based or services website between said one or more subscribed video clips and one or more parts of their e-commerce, information-based or services website pages;
(i) a client of said e-commerce, information-based or services website using said e-commerce, information-based or services website through a client's web-browser, and said client entering a query on said respective e-commerce, information-based or services website via said client's web-browser;
(j) matching at the e-commerce, information-based or services website said query information entered by said client in said e-commerce, information-based or services website to said one or more of said created relationships;
(k) presenting in one webpage in said client's web-browser the webpage each of the matched and related web page and subscribed video clips; and
(l) automatically playing back to said client and in said webpage in said client's web-browser the matched and related video clip whereby for said playback the video content is downloaded from the video-clip-website.

8. The method as set forth in claim 7, wherein said categorizing and indexing further comprises routinely updating said categorization and indexing based on relevance parameters regarding said identified video content.

9. The method as set forth in claim 7, further comprising storing preferences for said e-commerce provider regarding said provider's search and subscription history on said categorized database.

10. The method as set forth in claim 7, further comprising storing preferences for said client regarding said client's query history on said e-commerce, information-based or services site.

11. The method as set forth in claim 7, further comprising presenting or distributing said database to individuals, marketers, webmasters or bloggers.
